(19) United States
(12) Patent Application Publication
(10) Pub. No.: US 2005/0090264 A1
(43) Pub. Date: Apr. 28, 2005

(54) Broadcast method in WPAN and communication system using the same

(75) Inventor: Won-soo Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/968,909

(22) Filed: Oct. 21, 2004

(30) Foreign Application Priority Data
Oct. 28, 2003 (KR) 2003-75363

(51) Int. Cl. H04Q 7/20

(52) U.S. Cl. 455/455

(57) ABSTRACT

A broadcast method and communication system of a wireless network is disclosed. In a wireless network consisting of a plurality of connected devices in which one device is selected to be a coordinator and the rest of the devices are synchronized to a synchronous signal broadcasted by the coordinator, the broadcast method includes the steps of checking whether one of a current channel and a PAN ID of the wireless network needs to be changed; and inserting a change information for changing one of the channel and the PAN ID in the synchronous signal and broadcasting the synchronous signal, when one of the channel and the PAN ID is determined to be changed in the checking step.

This application claims the benefit of Korean Patent Application No. 2003-75363 filed Oct. 28, 2003, in the Korean Intellectual Property Office, the disclosure of which is incorporated herein by reference.

### BACKGROUND OF THE INVENTION

1. Field of the Invention

The present invention relates generally to a broadcast method and a communication system using the same, and more particularly, to a broadcast method in a wireless personal area network which enables stable reception of broadcast content at IEEE 802.15.4 devices linked to the wireless personal area network, and a communication system using the same.

2. Description of the Related Art

A personal area network, briefly called as PAN, is based on the concept that each individual user has his own network, which is contrary to the concept of LAN and WAN. The PAN constructs a network with the devices owned by the individual user for the user's convenience, and the Wireless PAN (WPAN) has been suggested to realize the PAN in the wireless manner.

In an effort to establish PAN in the wireless manner, IEEE 802.15 Working Group has set WPAN as the standard of the short-distance wireless network, and has four task groups (TG). IEEE 802.15.1 is well known as ‘Bluetooth’, and IEEE 802.15.3 and IEEE 802.15.3a perform standardization of the high-rate WPAN, and IEEE 802.15.4, or ZigBee, performs low-rate WPAN below speeds of 250 kbps.

FIG. 1 illustrates the structure of a general WPAN. Referring to FIG. 1, a plurality of devices 10, 12, 14, 16 and 18 construct a network, and one of the devices 10 is selected as a coordinator. The coordinator 10 broadcasts a synchronous signal, a beacon frame, to the rest of devices 12, 14, 16, and 18 in order to to synchronize them. In the WPAN, communication ranges of the neighboring networks sometimes overlap with each other, resulting in interference.

FIG. 2 illustrates communication ranges of two adjacent WPANs partially overlapping each other. Referring to FIG. 2, the first WPAN 40, which is synchronized by the coordinator A 20, and the second WPAN 50, which is synchronized by the coordinator B 30, have a partially overlapping communication area. If a frequency of these two WPANs 40 and 50 overlap, or if the WPANs 40 and 50 use an identical PAN ID, devices 28 and 36 within the overlap area do not perform smooth communication, and therefore, the coordinator has to change the currently-used channel or PAN ID.

According to IEEE 802.15.4, if the same PAN ID is used in two different WPANs, the device recognizing this fact notifies the coordinator of the network with the PAN ID conflict notification command which is shown in detail in FIG. 3. Responsive to the PAN ID conflict notification command, the coordinator broadcasts a coordinator realignment command to the devices, instructing them to change their PAN ID. The channel is changed in a likewise way. That is, the coordinator broadcasts a coordinator realignment command to the devices, instructing to change the currently-used channel to another one.

The problem is that not all the devices within the network are in an RX_ON state to receive the coordinator realignment command broadcasted from the coordinator. In other words, some devices may not be able to receive the broadcast coordinator realignment command, and as these devices do not know about the changed channel or PAN ID, become orphan in state in which the device cannot communicate with other devices. In order to escape from the orphan state, the device undergoes synchronization and orphan scan processes. The following equation represents the overhead time for the synchronization and orphan scan.
Overhead Time by Synchronization=Symbol Duration*Base Superframe Duration*(2^{B0}+1)*Max Lost Beacons=16 μs*(960*(2^{BO}+1))*4 [Equation 1]
where, 0≦B0≦14, in which BO represents a Beacon Order.

The overhead time for orphan scan is represented as follows:
Overhead Time by Orphan Scan=Response Wait Time*Number of Scan Channel=30720 symbols*16 μs/symbol*Number of Scan Channel [Equation 2]
where, 1≦Number of Scan Channel≦16.

By the Equations 1 and 2, it can be estimated that approximately 0.12 s to 1006 s of overhead time, depending on the length of beacon frame, is necessary for the synchronization, and approximately 492 ms to 7872 ms of overhead time, depending on the number of scan channels, is necessary for the orphan scan.

The overhead time of isolated devices for the synchronization and orphan scan causes deterioration of overall communication efficiency of the communication system. Therefore, it is necessary to guarantee the reception of broadcast information at each linked device of the WPAN to avoid such deterioration of communication efficiency.

### SUMMARY OF THE INVENTION

The present invention addresses the above drawbacks and other problems associated with the conventional arrangement. An aspect of the present invention is to provide a broadcast method in a WPAN, which guarantees high communication efficiency by ensuring a reception of broadcast information at each device of the WPAN, and a communication system using the same.

The above aspects and/or other features of the present invention can be substantially achieved by providing a broadcast method of a wireless network consisting of a plurality of connected devices in which one device is selected to be a coordinator and the rest of the devices are synchronized to a synchronous signal broadcasted by the coordinator, which comprises the steps of: checking to see whether one of a current channel and a PAN ID of the wireless network needs to be changed or not; and inserting a change information for changing one of the channel and the PAN ID in the synchronous signal and broadcasting the synchronous signal, when one of the channel and the PAN ID is determined to be changed in the checking step. Additionally, a step, in which the devices change one of the channel and the PAN ID based on the change information inserted in the synchronous signal, is further provided.

The wireless network is a low-rate wireless personal area network under the IEEE 802.15.4 standard. The synchronous signal is a beacon frame. The change information comprises a coordinator realignment command inserted in a payload field of the beacon frame, and a predetermined identify bit inserted in the reserved bit of a frame control field of the beacon frame. Whether to change the PAN ID or not is determined based on a PAN ID conflict command transmitted from one of the plurality of connected devices.

Consistent with one aspect of the present invention, a communication system comprises: at least one device connected to a wireless network; and a coordinator for synchronizing the devices by broadcasting a synchronous signal. The coordinator checks to see whether one of a current channel and a PAN ID of the wireless network needs to be changed or not, and if so, inserts a change information for changing one of the channel and the PAN ID in the synchronous signal and broadcasting the synchronous signal.

The coordinator comprises: a transmitting and a receiving unit for providing a communication interface for communication with the connected devices: a channel status notifying unit for checking to see whether the channel needs to be changed or not and outputting a corresponding signal; a channel selection management unit for outputting a change information of the channel in accordance with the signal outputted from the channel status notifying unit; a PAN ID changing unit for checking to see whether the PAN ID needs to be changed or not, and if so, outputting a change information of the PAN ID; and a beacon frame generating unit for inserting the change signal from the channel selection management unit and the PAN ID change notifying unit in the synchronous signal, and broadcasting the synchronous signal to the connected devices.

The connected devices each comprises: a transmitting and receiving unit for providing a communication interface with the coordinator; a beacon frame interpretation unit for extracting the change information from the synchronous signal; a channel changing unit for changing the channel according to the extracted change information; and a PAN ID changing unit for changing the PAN ID according to the extracted change information.

The wireless network is a low-rate wireless personal area network (WPAN) under the IEEE 802.15.4 standard. The synchronous signal is a beacon frame. The change information comprises a coordinator realignment command inserted in a payload field of the beacon frame, and a predetermined identify bit inserted in the reserved bit of a frame control field of the beacon frame. Whether to change the PAN ID or not is determined based on a PAN ID conflict command transmitted from one of the plurality of connected devices.

### BRIEF DESCRIPTION OF THE DRAWINGS

The above aspects and features of the present invention will be more apparent by describing certain embodiments of the present invention with reference to the accompanying drawings, in which:

FIG. 1 is a view illustrating the structure of a general wireless personal area network (WPAN);

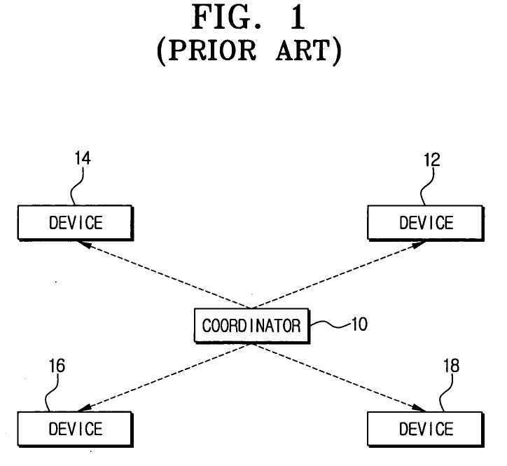

FIG. 2 is a view illustrating the communication ranges of two neighboring WPANs partially overlapping;

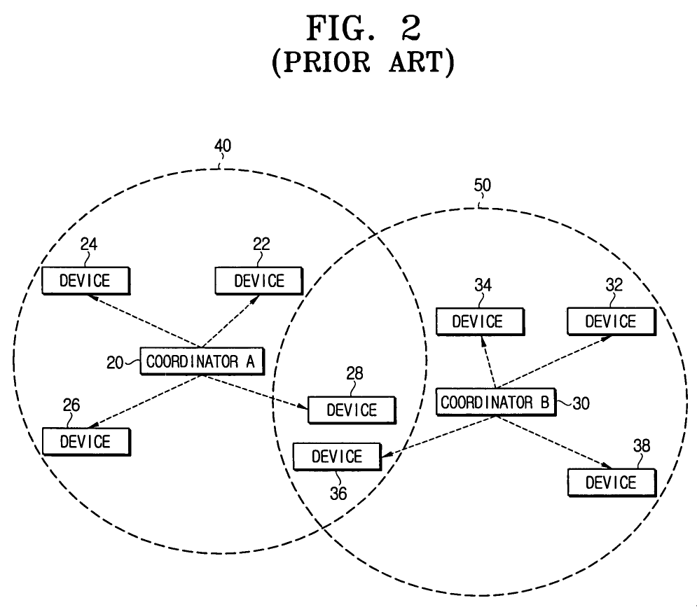

FIG. 3 is a view illustrating the structure of a coordinator realignment command;

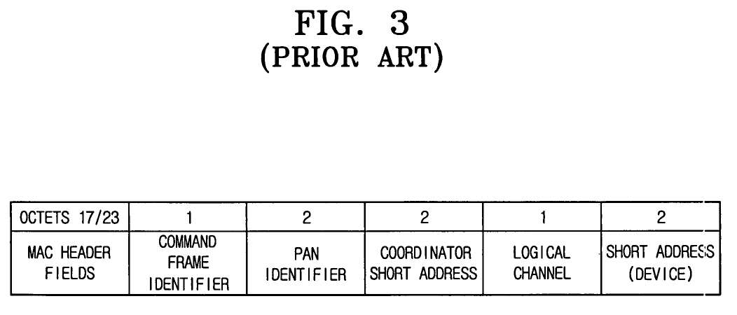

FIGS. 4 and 5 are schematic block diagrams of a communication system using the broadcast method consistent with an embodiment of the present invention;

FIG. 6 is a flowchart outlining the broadcast method consistent with an embodiment of the present invention;

FIG. 7 is a view illustrating the structure of a beacon frame which is used by the broadcast method consistent with an embodiment of the present invention; and

FIG. 8 is a view outlining the broadcast method consistent with an embodiment of the present invention.

### DETAILED DESCRIPTION OF THE EXEMPLARY EMBODIMENTS

Certain exemplary embodiments of the present invention will be described in greater detail with reference to the accompanying drawings.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

In the following exemplary embodiment of the present invention, the broadcast method will be applied in the IEEE 802.15.4 WPAN. However, it will be appreciated that it is only for exemplary purposes, and the present invention can be applied in various wireless network environments so long as it satisfies the conditions consistent with the present invention.

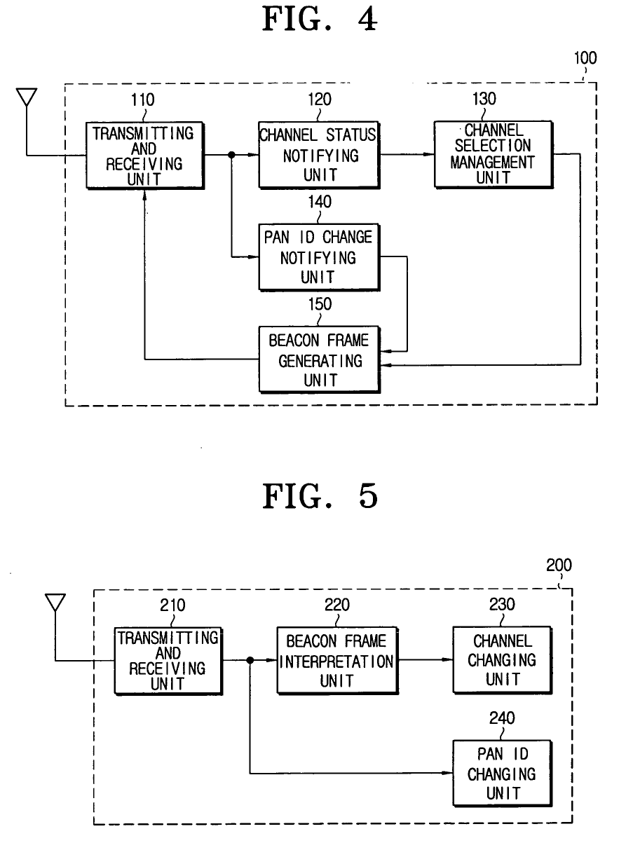

FIGS. 4 and 5 are schematic block diagrams of a communication system using a broadcast method consistent with an embodiment of the present invention. More specifically, FIG. 4 is a schematic block diagram of a wireless communication device which operates as a coordinator, and FIG. 5 is a schematic block diagram of a wireless communication device which operates as a device.

Referring to FIG. 4, the coordinator 100 comprises a transmitting and receiving unit 110, a channel status notifying unit 120, a channel selection management unit 110, a PAN ID change notifying unit 140 and a beacon frame generating unit 150.

The transmitting and receiving unit 110 provides a communication interface for communication with other communication devices. The channel status notifying unit 120 checks the status of the channel in use, and if need arises, notifies the channel selection management unit 130 to change the channel. The channel selection management unit 130, responsive to the notification from the channel status notifying unit 120, selects a new communication channel, and transmits related information to the beacon frame generating unit 150.

When the PAN ID conflict notification command is received from a certain device of the WPAN, the PAN ID change notifying unit 140 interprets the command, changes the PAN ID, and transmits the related information to the beacon frame generating unit 150.

With reference to the information transmitted from the channel selection management unit 130 or the PAN ID change notifying unit 140, the beacon frame generating unit 150 generates a beacon frame which contains therein the communication channel or PAN ID change information, and the generated beacon frame is broadcast to the linked devices of the WPAN.

Referring to FIG. 5, the linked wireless communication devices 200 of the WPAN each comprises a transmitting and receiving unit 210, a beacon frame interpretation unit 220, a channel changing unit 230 and a PAN ID changing unit 240.

The transmitting and receiving unit 210 provides a communication interface for communication with other communication devices. The beacon frame interpretation unit 220 interprets the beacon frame broadcasted from the coordinator, if the information about a change of communication channel or PAN ID is contained in the beacon frame, the beacon frame interpretation unit 220 extracts the information about the change and transmits the extracted information to the channel changing unit 230 or PAN ID changing unit 240. The channel changing unit 230 selects a new communication channel according to the change information which is transmitted from the beacon frame interpretation unit 220. In the same way, the PAN ID is changed at the PAN ID changing unit 240 based on the information transmitted from the beacon frame interpretation unit 220.

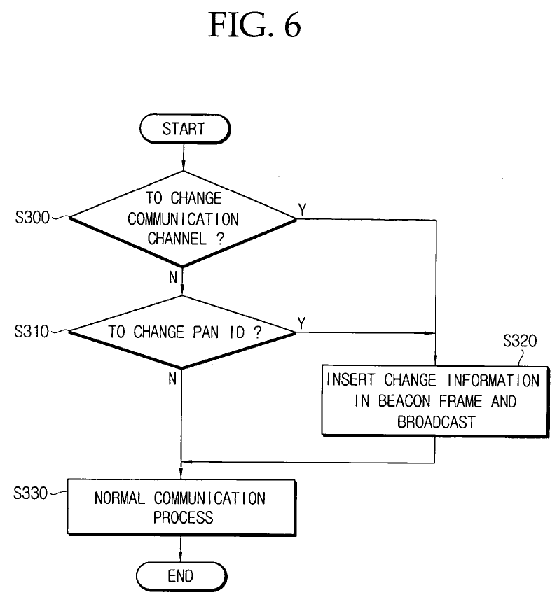

FIG. 6 is a flowchart illustrating a broadcast method of a WPAN consistent with an embodiment of the present invention.

Referring to FIGS. 4 to 6, the wireless communication device 100 operating as a coordinator, checks to see whether a new channel is necessary because the channel status has deteriorated due to factors such as interference with an adjacent network (S300). If there is no need to change the current channel, the coordinator 100 checks to see whether a PAN ID conflict notification command is transmitted from the devices, requesting to change the current PAN ID (S310). If there is no need to change the PAN ID, communication processes are carried out (S330).

If checking at S300 or S310 indicates a need for a channel or a PAN ID change, the information about change of a channel or a PAN ID is inserted in the beacon frame and the beacon frame is broadcasted (S320). Then normal communication processes are carried out (S330). By utilizing the fact that the linked devices are in the information receivable state with respect to the coordinator in the process of the beacon frame broadcast, the information about change is inserted in the broadcast frame and as a result, the devices can be prevented from becoming isolated due to an inability of receiving the change information.

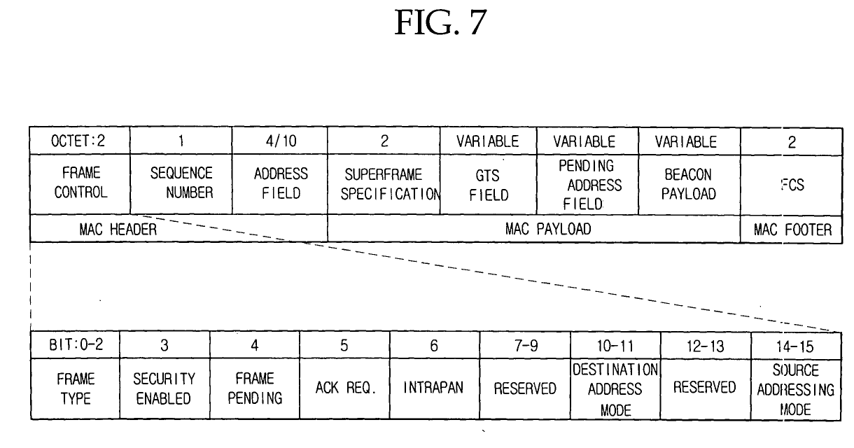

FIG. 7 illustrates the structure of beacon frame which is used by the broadcast method of a WPAN consistent with one embodiment of the present invention.

Referring to FIG. 7, a beacon frame comprises a frame control field, a sequence number field, an address field, a superframe specification field, a guaranteed timeslot (GTS) field, a pending address field, a beacon payload field, and a frame check sequence (FCS) field. As shown in FIG. 7, a beacon frame broadcasted by the coordinator 100 generally meets the conditions under the IEEE 802.15.4 standard, except for the fact that a coordinator realignment command is inserted in the payload of the beacon frame and thus requires an identify bit in the 12-13 reserved bits of the frame control field.

Accordingly, if the 12-13 reserved bits indicate a value ‘00’, it indicates that there is no coordinator realignment command in the payload field of the beacon frame, while if the value is ‘01’, it indicates that the coordinator realignment command for the change of channel is inserted in the payload of the beacon frame. If the reserved bits indicates a value ‘11’, there is a coordinator realignment command for a PAN ID change being inserted in the payload of the beacon frame. Accordingly, the devices can change a channel or a PAN ID if they receive a beacon frame and find the identify bit and coordinator realignment command. Meanwhile, under the IEEE 802.15.4 standard which uses 27 channels, a channel is indicated using 5 bits and a PAN ID is indicated using 16 bits.

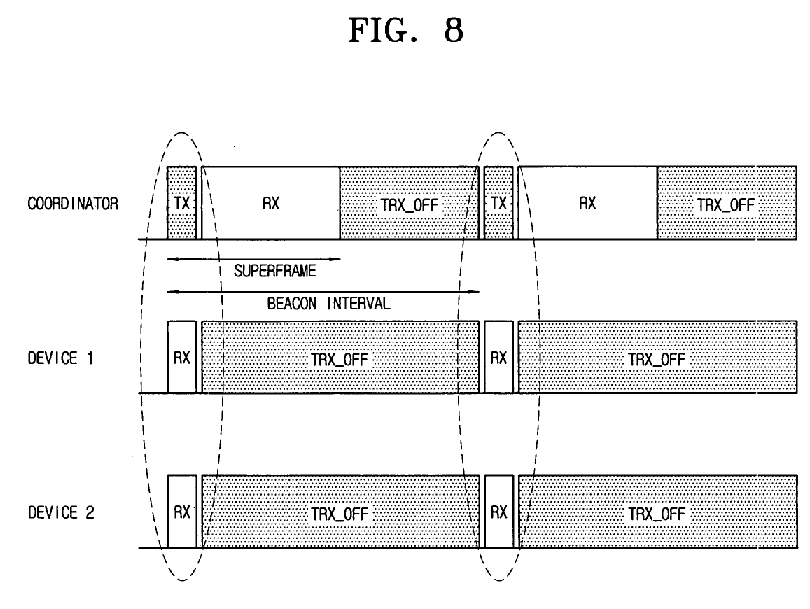

FIG. 8 is a view illustrating a broadcast method of a wireless network consistent with one embodiment of the present invention.

Referring to FIG. 8, the coordinator 100 broadcasts a beacon frame when the devices 200 are in the RX_ON state which can receive data. The area in the dotted ellipse represents a data receivable area. Accordingly, by inserting the change information of a channel or a PAN ID in the beacon frame and transmitting the beacon frame when the devices of the network are in data receivable state, it is ensured that all the devices in the network can receive the change information.

As described above in a few exemplary embodiments of the present invention, the change information of a channel or PAN ID is inserted in the beacon frame and the beacon frame is broadcast to the devices of the network. As a result, all the devices within the network can receive the change information and therefore, are prevented from becoming isolated. Because there is no overhead time required for performing re-synchronization or an orphan scan, overall communication efficiency improves.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A broadcast method of a wireless network comprising a plurality of connected devices in which one of the plurality of connected devices is selected to be a coordinator and the rest of the plurality of connected devices are synchronized to a synchronous signal broadcasted by the coordinator, the broadcast method comprising:
checking whether one of a current channel and a personal area network (PAN) ID of the wireless network needs to be changed; and
inserting a change information for changing one of the channel and the PAN ID in the synchronous signal and broadcasting the synchronous signal, when it is determined in the checking that one of the channel and the PAN ID needs to be changed.

2. The broadcast method of claim 1, further comprising by the plurality of connected devices, changing one of the channel and the PAN ID based on the change information inserted in the synchronous signal.

3. The broadcast method of claim 2, wherein the wireless network is a low-rate wireless personal area network under the IEEE 802.15.4 standard.

4. The broadcast method of claim 1, wherein the synchronous signal is a beacon frame.

5. The broadcast method of claim 4, wherein the change information comprises a coordinator realignment command inserted in a payload field of the beam frame, and a predetermined identify bit inserted in the reserved bit of a frame control field of the beacon frame.

6. The broadcast method of claim 1, wherein whether to change the PAN ID is determined based on a PAN ID conflict command transmitted from one of the plurality of connected devices.

7. A communication system comprising:
one or more devices connected to a wireless network; and
a coordinator for synchronizing the one or more devices by broadcasting a synchronous signal, wherein the coordinator checks whether one of a current channel and a PAN ID of the wireless network needs to be changed, and if so, inserts a change information for changing one of the channel and the PAN ID in the synchronous signal, and broadcasting the synchronous signal.

8. The communication system of claim 7, wherein the coordinator comprises:
a transmitting and receiving unit operable to provide a communication interface for communication with the one or more devices;
a channel status notifying unit operable to check whether the channel needs to be changed and outputting a corresponding signal;
a channel selection management unit operable to output a change information of the channel in accordance with the signal outputted from the channel status notifying unit;
a PAN ID changing unit operable to check whether the PAN ID needs to be changed, and if so, outputting a change information of the PAN ID; and
a beacon frame generating unit operable to insert the change signal from the channel selection management unit and the PAN ID change notifying unit in the synchronous signal, and broadcasting the synchronous signal to the one or more devices.

9. The communication system of claim 7, wherein the one or more devices each comprises:
a transmitting and receiving unit operable to provide a communication interface with the coordinator;
a beacon frame interpretation unit operable to extract the change information from the synchronous signal;
a channel changing unit operable to change the channel according to the extracted change information; and
a PAN ID changing unit operable to change the PAN ID according to the extracted change information.

10. The communication system of claim 7, wherein the wireless network is a low-rate wireless personal area network (WPAN) under the IEEE 802.15.4 standard.

11. The communication system of claim 7, wherein the synchronous signal is a beacon frame.

12. The communication system of claim 11, wherein the change information comprises a coordinator realignment command inserted in a payload field of the beacon frame, and a predetermined identify bit inserted in the reserved bit of a frame control field of the beacon frame.

13. The communication system of claim 7, wherein the PAN ID is changed according to a PAN ID conflict command transmitted from the one or more devices connected to the wireless network.
